(19) United States
(12) Patent Application Publication
(10) Pub. No.: US 2006/0234624 A1
(43) Pub. Date: Oct. 19, 2006

(54) System and method of dynamic packet transmission for AGPS

(76) Inventor: Chun-Nan Yeh, Nantou (TW)

Correspondence Address: HARNESS, DICKEY & PIERCE, P.L.C., P.O. BOX 8910, RESTON, VA, 20195, US

(21) Appl. No.: 11/402,909

(22) Filed: Apr. 13, 2006

(30) Foreign Application Priority Data
Apr. 13, 2005 (TW) 094111745

(51) Int. Cl. H04H 1/00

(52) U.S. Cl. 455/3.02

(57) ABSTRACT

A system and method for dynamically transferring satellite data packets through GPRS (General Packet Radio Service) in an AGPS(Assisted Global Positioning System) is disclosed. The satellite data are transmitted in dynamic size of segments so as to improve the transmission efficiency. When the network communication is stalled or broken, the segments being successfully received are not necessary to be resent. But only the failed segments are re-transmitted so that the time and bandwidth for data transmission are reduced, and the positioning process is prevented from delay by the transmission failure.

### CROSS-REFERENCE TO RELATED APPLICATIONS

This non-provisional application claims priority under 35 U.S.C. § 119(a) on Patent Application No(s). 094111745 filed in Taiwan, R.O.C. on Apr. 13, 2005, the entire contents of which are hereby incorporated by reference.

### BACKGROUND OF THE INVENTION

1. Field of Invention

The invention generally relates to a system and method for improving data packet transmission, and in particular relates to a system and method for dynamically transferring data packets in an AGPS (Assisted Global Positioning System).

2. Related Art

FIG. 1 shows a schematic diagram of an AGPS (Assisted Global Positioning System). The major difference between AGPS and stand-alone GPS (Global Positioning System) is that the GPS must search for satellite 140 signals and decode the satellite navigation messages before computing its position. The tasks require strong signals and additional processing time. The AGPS applies cellular telephone 110 through BSS of GSM (Basic Station System of Global System for Mobile communications;) 130 to get the micro-cell 150 where the user belongs to and to provide an initial approximate position of a GPS receiver. By obtaining the navigation messages of satellites covering the micro-cell 150 through a server 120, the receiver can therefore utilize weaker signals and also more quickly determine its position. Mainly, the required time for a first time positioning is decreased form original 5 or 10 minutes to 10 second. The time for further positioning is decreased from 40 seconds to 1 or 2 seconds. The drawbacks of weak signal and failed communication in conventional GPS when user moving in a building are also overcame.

At a first time positioning of a global positioning system, the GPS receiver has to search satellite orbit and clock data in an outdoor open space. There are at least 24 satellites moving around the earth in a 12-hour cycle and providing specific coded signals. The GPS receiver has to obtain at least data of three satellites for calculating the current position or speed of the user from the satellite data. In accompany with technology developments, cellar phones are being developed with multiple functions, such as including personal digital assistant; or even a navigation system utilizing global satellite positioning. The satellite data acquiring and transmission are via GPRS (General Packet Radio Service) for the cellar phone.

The GPRS is a new (2.5) generation GSM communication standard based on packet switch (instead of general circuit switch) transmission so as to improve data transmission rate and achieve high-speed wideband communication.

The data transmission through GPRS is to deliver a serial of packets, instead of a full line transmission, so as to share the network resources with others and to fully utilize the limited bandwidth. In the AGPS, the packet size is 100 kilobytes. The GPRS also applies Internet protocol so as to interconnect with Internet.

However, since radio signals are easy to be influenced by geography and environments, the quality of radio communication goes down by interferences of multi-path, path fading, shielding effect and so on. For example, a micro-cell encounters co-channel interface with another micro-cell of the same carrier frequency; the cellar phones in a micro-cell encounter adjacent channel interference caused by carrier frequencies of adjacent micro-cells. All these interferences influence the radio signal quality of cellar phones in the micro-cells.

As users of cellar phones increase, the bandwidths allocated for each phone decrease. Since the total phone users in a micro-cell vary anytime, the bandwidth for each cellar phone varies accordingly. For example, supposing a bus carrying many cellar phone users into a micro-cell, the bandwidth allocated to each phone decreases promptly since the users increase. The variations of bandwidth of communication make the delay of each data packet transmission from the source to the target varying a lot.

When cellar phone users getting into tunnels, trains or some dead angles of communication, the cellar phones temporarily lose signals. The radio signals are unstable and the packet transmissions fail easily. Each time when data transmission fails, the data packet has to be re-transmitted that lowers the communication efficiency. Further, since the data transmission fee is paid according to the data quantity regardless of transmission success or not, the transmission failure wastes more time and cost. Therefore, it is an important issue to improve the efficiency of data transmission.

### SUMMARY OF THE INVENTION

The object of the invention is to provide a system and method for dynamically transferring data packets in an AGPS (Assisted Global Positioning System). The data packets are transmitted and received in segments. When the network communication is stalled or broken, the segments being successfully received are not necessary to be resent. But only the failed segments are re-transmitted so that the time and bandwidth for data transmission are reduced, and the positioning process is prevented from delay by the transmission failure.

In order to achieve the aforesaid object, a system for dynamically transferring data packets in an AGPS according to the invention includes a server, a BSS (Basic Station System) and a cellar phone with AGPS.

The Basic Station System is used to receive the positioning request of the cellar phone, transfer the request to the server, and transfer the satellite data to the cellar phone.

The server searches correspondent satellite data of the micro-cell where the AGPS cellar phone locates according to the request of the cellar phone, and transmits the satellite data in segments. The server includes a satellite database for storing data of each satellite in a coverage range of the Basic Station System based on every time period; and a central processing unit for dynamically determining the segmentation of satellite data transmission.

The AGPS cellar phone is used to get data of the satellites that cover the current position of the cellar phone and to determine the position. The cellar phone includes: a communication module for transmitting the request of acquiring satellite data and afterwards receiving the satellite data segments; a control module for monitoring a reception status of each data segment and integrating the satellite data after receiving all the data segments; and a memory module for registering the received satellite data segments.

A method for dynamically transferring data packets in an AGPS according to the invention includes the following steps. First, a cellar phone requests satellite data through a basic station system. A server determines the position of the cellar phone according to the requests from the basic station system; and transmits data segments of the satellites corresponding to the cellar phone position. The cellar phone stores the data segments in a register; and finally integrates the satellite data segments into complete data for the positioning function.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description. On the other hand, some well-known methods, processes, components and circuits are not described in details in order to prevent from confusing the merit of the invention.

### BRIEF DESCRIPTION OF THE DRAWINGS

The present invention will become more fully understood from the detailed description given hereinbelow illustration only, and thus are not limitative of the present invention, and wherein:

FIG. 1 is a compositional view of an AGPS cellar phone in the prior art;

FIG. 2 is a schematic diagram of the invention;

FIG. 3 is a flowchart of the invention at the cellar phone side; and

FIG. 4 is a flowchart of the invention at the server side.

### DETAILED DESCRIPTION OF THE INVENTION

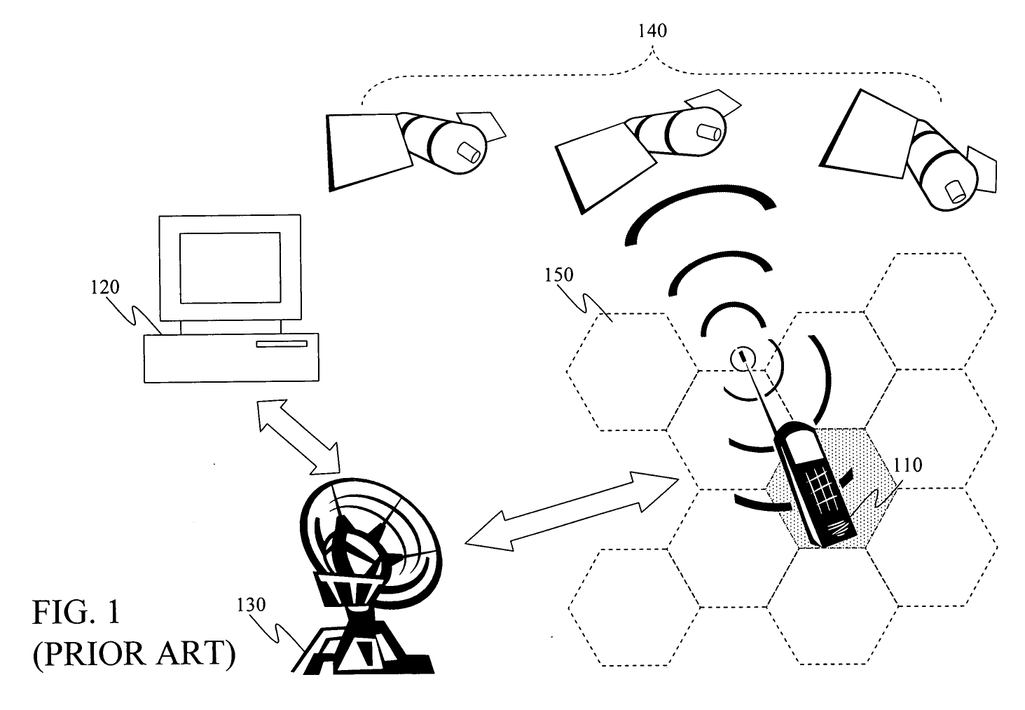

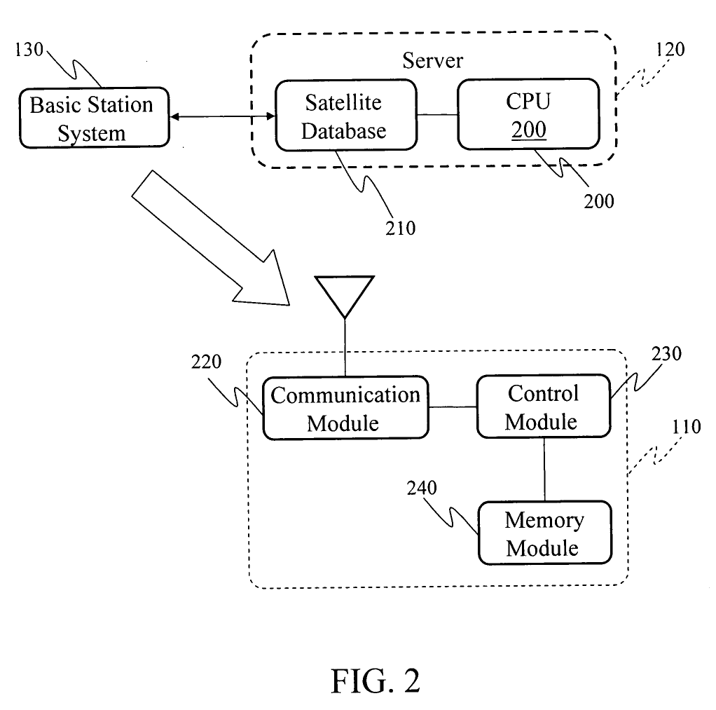

As shown in FIG. 1 and FIG. 2, a Basic Station System 130 serves a plurality of honeycomb micro-cells 150 through radio signal communications. A cellar phone 110 with AGPS (Assisted Global Positioning System) in any a micro-cell 150 sends a request to the server 120 for acquiring satellite data through interconnected stations in the Basic Station System 130. The data of satellites 140 are managed by the server 120 and transmitted through the Basic Station System 130 to the cellar phone 110.

The server 120 includes a satellite database 210 and a central processing unit 200 for locating the position of the cellar phone 110 according to the micro-cell 150 where the satellite data request from the cellar phone 110 being sent out. Then, the corresponding satellite data are divided into segments and transmitted through GPRS (General Packet Radio Service). The GPRS transmission is not quite fast, therefore, the segmentation prevents the time waste of repeated whole packet transmission when encountering network stall or communication break.

The satellite database 210 stores the coverage positions of each satellite 140 at every time periods. Generally, a GPS receiver requires several minutes to find out the satellites 140 that cover the current position by continuously receiving the satellite data for a while. However, since the atmosphere conditions, building shielding and signal diffusion are all influencing on the accuracy of positioning, the GPS receiver usually spends a lot of time searching the satellites 140 when the signals are unstable. On the contrary, since the satellites are moving above the earth in a fixed speed like on-time trains, using the database 210 to locate the satellites 140 can help the AGPS cellar phone 110 quickly achieve the cold start procedure.

The central processing unit 200 dynamically determines the segmentation of the satellite data to be transmitted. Since the transmission of the GPRS is unstable that many cases, such as fast motion, mountain, tunnel or building shielding, rush communication, network stall and so on, greatly increase the loss rate of packets. Once the packet transmission fails, it has to be re-transmitted. Therefore, the invention monitors the packet transmission condition and dynamically adjusts the packet size. For example, the original size of a packet is 100 kilobytes that is hard to be finished in a time slot when the network being stalled, so the packet transmission fails. Then, the 100 kilobytes data are divided into four segments each carries 25 kilobytes in transmission. Then, if a segment fails in transmission, it is further subdivided. For example, if the third segment fails, it is subdivided into 5 kilobyte segments for transmission. After the communication condition being improved, the larger segment transmission is resumed. The AGPS cellar phone 110 receives the data of the satellites 140 that cover the position of current micro-cell 150 and fast finishes the cold start procedure of the global positioning system. The cellar phone 110 includes the following components:
a) a communication module 220, including a radio frequency transceiver, for transmitting the satellite data request from the cellar phone 110 to the Basic Station System 130; and receiving the satellite data from the server 120 via the Basic Station System 130;
b) a control module 230 for monitoring the reception condition of the satellite data through the communication module 220. The server 120 first provides a one-byte data recording the size of the segment to be transmitted. The control module 230 monitors the received data size and checks an ending tag to judge if the reception succeeds. After all the segments being fully received, the control module 230 integrates them into complete satellite data; and
c) a memory module 240 for registering the satellite data segments. To fulfill the requirements of fast and repeated reading/writing, SRAM (static random access memory) or DRAM (dynamic random access memory) are preferably used though they are relatively expensive. Fortunately, since the satellite data are less, only small memory size is needed.

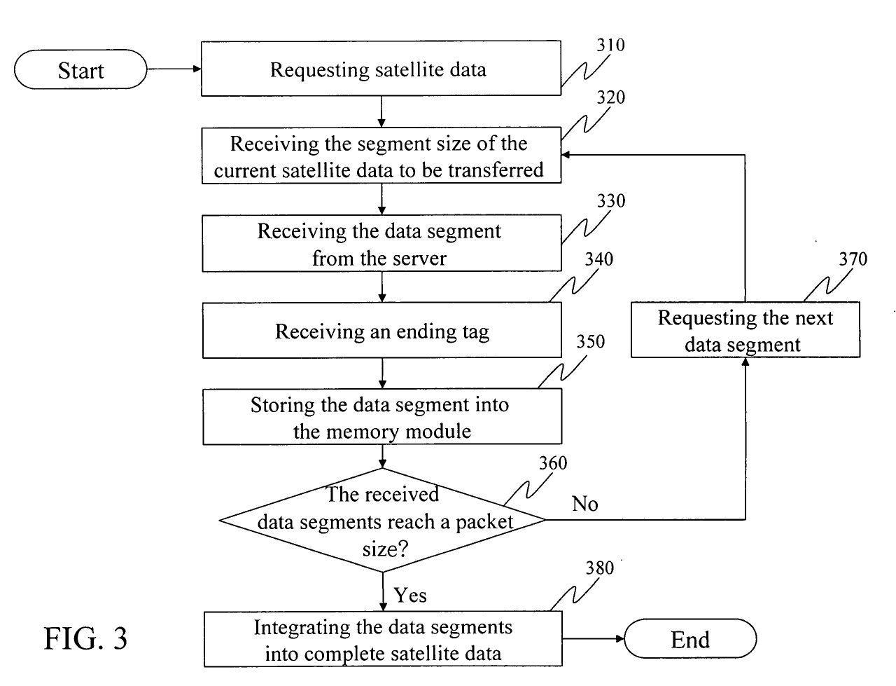

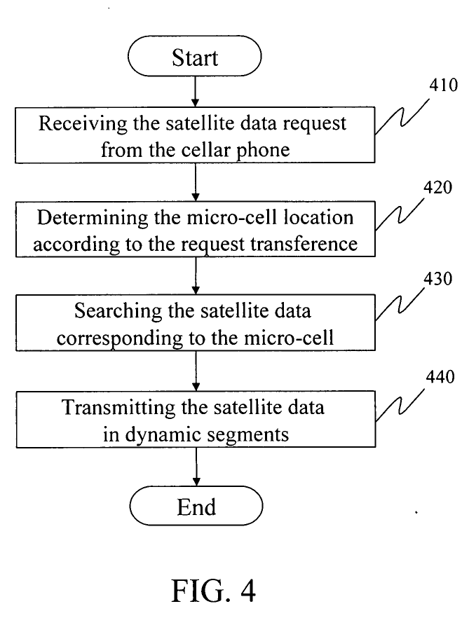

FIG. 3 and FIG. 4 are flowcharts of an assisted global satellite positioning method of the invention at the cellar phone side and at the server side respectively. The GPS receiver in the cellar phone 110 requires a cold start procedure to find out the satellites 140 corresponding to the current position. The communication module 220 sends a request to the server 120 for acquiring satellite data (step 310). The request is transmitted by radio signals through the interconnected stations of the BSS (Basic Station System) 130 around the current micro-cell 150 where the cellar phone locates. The request passes through stations of the BSS 130 to the server 120.

The server 120 receives the satellite data request from the cellar phone (step 410). Because each station around the micro-cell 150 where the cellar phone 110 locates transfers the request to the server 120, the server 120 checks the transfer sequence of the request to find out the location of the micro-cell 150 (step 420). Then, the server 120 searches with the database 210 by the current time the data of the satellites that cover the micro-cell 150 (step 430). The central processing unit 200 then checks the communication condition and controls the data segmentation of the satellite data transmission (step 440).

The AGPS cellar phone 110 first receives a one-byte data that records the segment size (length) of the current satellite data to be transferred (step 320). The communication module 130 then receives the data segment from the server 120 (step 330). When the received data size conforms and an ending tag arrives (step 340), the data segment reception is successful. Then, the data segment is stored into the memory module 240 (step 350). The control module 230 checks if all the received data segments reach a packet size, for example, 100 kilobytes in the embodiment (step 360). If not, the communication module 220 requests for the next data segment (step 370). After the total data segments reach the packet size, the data segments are integrated into complete satellite data (step 380).

After all the required satellite data being received, the AGPS cellar phone 110 can verify its position. The satellite data are transferred in dynamic segments to prevent from whole re-transmission when communication fails. The partial re-transmission reduces the transmission time and bandwidth waste, and improves the communication efficiency.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for dynamically and efficiently transferring satellite data packets in an AGPS (Assisted Global Positioning System), comprising:
a Basic Station System having a plurality of stations for transferring said satellite data packets;
a server for dynamically transmitting said satellite data in dynamic size of data segments, comprising a satellite database for storing data of each satellite in a coverage range of said Basic Station System based on every time period and a central processing unit for determining dynamic size of data segments of transmission of said satellite data; and
a AGPS cellar phone for requesting and receiving said satellite data covering a current position of said cellar phone, comprising:
a communication module for transmitting a request of acquiring satellite data and receiving said satellite data , a control module for monitoring a reception status of each satellite data segment and integrating said satellite data segments after receiving all satellite data segments, and a memory module for registering said received satellite data segments.

2. The system of claim 1 wherein said central processing unit determines sizes of data segments according to transmission conditions.

3. The system of claim 1 wherein said control module integrates said satellite data segments into a packet size of GPRS(General Packet Radio Service).

4. The system of claim 1 wherein said server transmits a segment size before transmitting each satellite data segment.

5. The system of claim 4 wherein said segment size data have a size of one kilobyte.

6. The system of claim 4 wherein said server transmits an ending tag after a data segment is completely transmitted.

7. The system of claim 1 wherein said current position of said cellar phone is determined by a micro-cell surrounded by stations of said Basic Station System that transfers said request of acquiring satellite data.

8. A method for transferring satellite data packets in an AGPS composed of a cellar phone, a Basic Station System and a server, comprising steps of:
sending a request for satellite data from said cellar phone through said Basic Station System to said server;
determining at said server a micro-cell position of said cellar phone according to stations of said Basic Station System that transfers said request for satellite data;
searching data of a plurality of satellites corresponding to said micro-cell;
transmitting data segments of said satellites in dynamic sizes;
receiving and storing said data segments at said cellar phone; and
integrating said data segments into complete satellite data after receiving all data segments.

9. The method of claim 8 wherein said server transmits a segment size data before transmitting each satellite data segment.

10. The method of claim 9 wherein said segment size data have a size of one kilobyte.

11. The method of claim 9 wherein said server transmits an ending tag after a data segment is completely transmitted.

12. The method of claim 8 wherein said satellite data segments are integrated into a packet size of GPRS.

13. The method of claim 8 wherein said cellar phone sends a request for next data segment when said data segments are not fully received.
